(19) United States
(12) Patent Application Publication
(10) Pub. No.: US 2016/0084957 A1
(43) Pub. Date: Mar. 24, 2016

(54) SONAR POSITIONING DEVICE

(71) Applicant: Precision Sonar, LLC, Lemont, IL (US)

(72) Inventors: Robert G. Krug, Wheaton, IL (US); Jeffrey J. Roman, Orlando, FL (US)

(73) Assignee: Precision Sonar, LLC, Lemont, IL (US)

(21) Appl. No.: 14/857,385

(22) Filed: Sep. 17, 2015

Related U.S. Application Data
(60) Provisional application No. 62/051,687, filed on Sep. 17, 2014.

(51) Int. Cl. G01S 15/93; B60W 30/16; G01S 7/526; G01S 15/10; G01S 7/64

(52) U.S. Cl. CPC G01S 15/93; G01S 15/10; G01S 7/64; G01S 7/526; B60W 30/16; B60W 2550/308

(57) ABSTRACT

A sonar device for positioning a second vehicle within relative proximity of a first vehicle, includes a light indicator having at least two light outputs. A controller has first and second settings calibrated to correspond to first and second signal strengths. The first signal strength corresponds to a near distance between the first and second vehicles. The second signal strength corresponds to a far distance between the vehicles. Based on the strength of a returned sonar signal, the controller actuates the light indicator to indicate when the vehicles are at the near distance from each other and when the vehicles are at the far distance from each other. The vehicle operators use the light indicators to regulate the actual distance between the two vehicles to be within the near and far distances.

### RELATED APPLICATIONS

This application claims the benefit of U.S. Provisional Application No. 62/051,687, filed Sep. 17, 2014 and assigned to a common assignee hereof. The disclosure and drawings of the foregoing provisional application are fully incorporated by reference herein.

### BACKGROUND OF THE INVENTION

Many vehicles that have delivery systems such as chutes or conveyors. Vehicles such as milling machines and combines transport material from a position in front of or underneath the vehicle and move the material into a second vehicle which typically has an open bed. It is critical that the vehicle delivery system transport the material into the open bed while not running into, and possibly damaging, the vehicle with the open bed or the delivery system itself.

One example of a vehicle with a delivery system transporting material to a vehicle with an open bed is a milling machine that is used to remove asphalt road beds. Removing and milling an old road bed requires a series of vehicles and a number of personnel to synchronize the operation of the milling machine with the trucks used to haul away recovered milled road bed. Along with the individual operators of the truck and milling machine, there is also usually a load man who spots the trucks to ensure that the milling machine conveyor does not hit the truck. The load man also ensures that the milled product hits the open bed. The operation may also use an oil man who manages the direction and orientation of the cut. A foreman may also be present to manage operation of the milling machine and coordinate operations of the milling machine and the series of trucks used to haul away the old road bed. It is desirable to reduce the labor invested into running such an operation and improve workplace safety.

Visual or auditory cues are usually provided to the operator of the milling machine by personnel on the job site. The operator of the milling machine does not usually communicate to the operator of the vehicle used to carry away the removed road bed. However, in the absence of a load man, the milling machine operator may communicate to the operator of the vehicle used to carry away the removed road bed by honking and/or hand gestures.

It is critical that the milling machine and the vehicle used to receive the material from the milling machine be in the proper position for three main reasons. First, the material that the milling machine removes from the road bed must fall off the conveyor into the open bed or receptacle of the second vehicle. Second, the open bed vehicle must avoid contact with and consequently damaging the conveyor. Third, the open bed of the vehicle must be filled evenly for efficiency and cost effectiveness.

Thus a need exists for a positioning system that can ensure material from a vehicle with a delivery system is transported efficiently the open bed of a second vehicle while keeping the conveyor system damage free. In addition a positioning system that does not use human beings in close proximity to dangerous machinery will be safer and may be more cost effective.

One possible solution is using sonar. Active sonar uses a sound transmitter and a receiver. Active sonar creates a pulse of sound, often called a “ping”, and then listens for reflections (echo) of the pulse. This pulse of sound is generally created electronically using a sonar projector consisting of a signal generator, power amplifier and electro-acoustic transducer/array. To measure the distance to an object, the time from transmission of a pulse to reception is measured and converted into a range by the known constant of the speed of sound.

Sonar technology is well known both in passive and active applications. Examples include Fisher, U.S. Pat. No. 8,492,692 which discloses an unnamed aerial vehicle based sonar buoy. Other patents include Thompson et al, U.S. Pat. No. 7,542,376, which teaches a vessel mountable sonar system comprising a sonar data acquisition device. Eyries, U.S. Pat. No. 6,856,580, teach a hull mounted sonar for a naval ship. Betts et al, U.S. Pat. No. 7,652,952, also teaches a sonar imaging system for mounting to a watercraft

### SUMMARY OF THE INVENTION

According to one aspect of the invention a sonar device is mounted on a first vehicle. A second vehicle is forwardly displaced from the first vehicle by an actual distance. A controller has two settings with one setting corresponding to a signal strength relating to a near distance between the first and second vehicles and the other setting corresponding to signal strength relating to a far distance between the first and second vehicles. The sonar device projects a signal onto the second vehicle and receives a reflected signal. The strength of the reflected signal corresponds to the actual distance between the vehicles. The strength of the reflected signal is compared to the first and second signal strengths and the controller actuates one or more light outputs on a light indicator. The operator of the second vehicle can respond to the lights by moving the vehicle forward as indicated resulting in a continuous regulation of the distance between the first and second vehicles.

According to another aspect of the invention, the controller actuates an audio indicator with audio signals corresponding to the first and second signal strengths. For example one long beep would correspond to the far distance and two short beeps would correspond to the near distance.

According to another aspect of the invention, a second vehicle is positioned in front of a first vehicle such that material from a delivery system of the first vehicle is deposited into an open receptacle of the second vehicle. A sonar signal is emitted from a transmitter of a sonar device mounted on the first vehicle. The sonar signal is reflected back from the second vehicle and received by the sonar device. The strength of the sonar signal is transmitted to the controller. A predetermined far signal strength and a predetermined near signal strength are set in the controller. The predetermined far signal strength corresponds to a predetermined far distance between the first and second vehicles. The predetermined near signal strength corresponds to a predetermined near distance between the first and second vehicles.

The sonar signal is compared to the predetermined far signal strength and the predetermined near signal strength. The controller actuates the first or second light outputs or both. The actual distance between the first and second vehicle is continuously regulated. The first light output is actuated when the second vehicle is the far distance from the first vehicle. The first vehicle is moved toward the second vehicle. The controller actuates the second light output when the actual distance between the vehicles is equal to the near distance. The second vehicle moves away from the first vehicle until the controller actuates the light corresponding to the far distance. At that point the second vehicle is stopped. This process is repeated a desired number of times.

In one embodiment of the invention, the second vehicle is a truck with an open bed that receives milled asphalt from a conveyor of the first vehicle, which is a milling machine.

### BRIEF DESCRIPTION OF THE FIGURES

Further aspects of the invention and their advantages can be discerned in the following detailed description, in which characters denote like parts and in which:

FIG. 1 is a side elevation of a first embodiment of the invention showing a milling machine and vehicle with an open bed;

FIG. 2 is a first top view of the embodiment of the invention shown in FIG. 1 with the two vehicles in non-linear alignment;

FIG. 3 is a second top view of the embodiment of the invention shown in FIG. 1;

FIG. 4 is a schematic diagram of a sonar positioning device according to one embodiment of the invention;

FIG. 5 is a circuit diagram of one embodiment of the invention;

FIG. 6 is a flow diagram showing a method of positioning two vehicles using the sonar positioning device;

FIG. 7 is a flow diagram showing a method of calibrating the sonar positioning device;

FIG. 8 is a circuit diagram of a second embodiment of the invention; and,

FIG. 9 is a flow diagram showing a method of positioning two vehicles using the sonar positioning device for the second embodiment of the invention.

### DETAILED DESCRIPTION

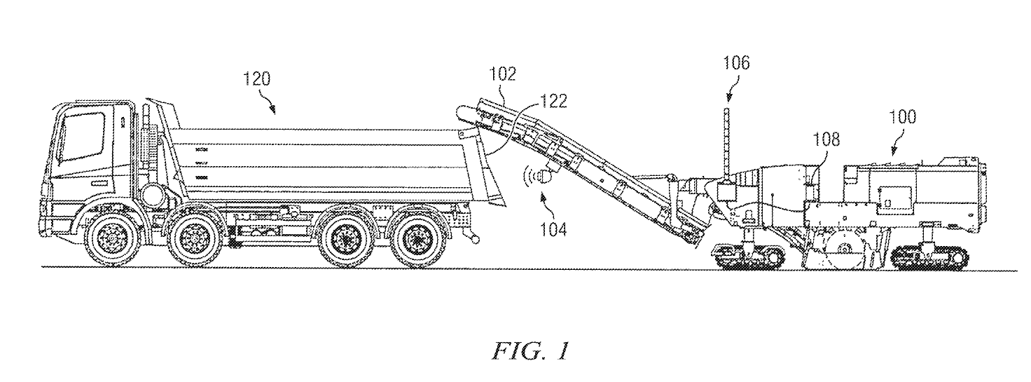

Various embodiments of the invention may now be seen through several views in the Figures. As can be seen in FIG. 1, one application for the invention is in the road paving industry where the operators of two motorized vehicles must work together to efficiently prepare roadway for repaving. The embodiment illustrated in FIG. 1 shows a milling machine 100 and a truck 120 with an open receptacle 124. In operation the second vehicle 120 is positioned such that material from the first vehicle 100 is transported into the open bed 124. The first vehicle 100 moves forward and when it is at a predetermined near distance from the second vehicle 120, the second vehicle 120 drives forward until a predetermined far distance is attained. This process continues for a predetermined amount or time or number of cycles determined by the amount of material in the open bed 124 or the remaining road bed to be milled.

Other embodiments may include applications in which a motor vehicle with a delivery system such as a conveyor belt 102, elevator, or chute is used. As illustrated in FIG. 1, the invention generally comprises a sonar transmitter and receiver (sonar device) 104, a visual indicator or light indicator 106 and a control box or controller 108.

In the embodiment illustrated in FIG. 1, the sonar device 104 transmits a sonar pulse from a position on the milling machine 100 to the vehicle 120 in front of it which is serving as a receptacle for the pavement that has been cut from the roadway. Generally the sonar device 104 may be mounted on any part of the milling machine 100 which produces an acceptable result. Other embodiments may have a sonar device 104 mounted on a vehicle that is not a milling machine 100.

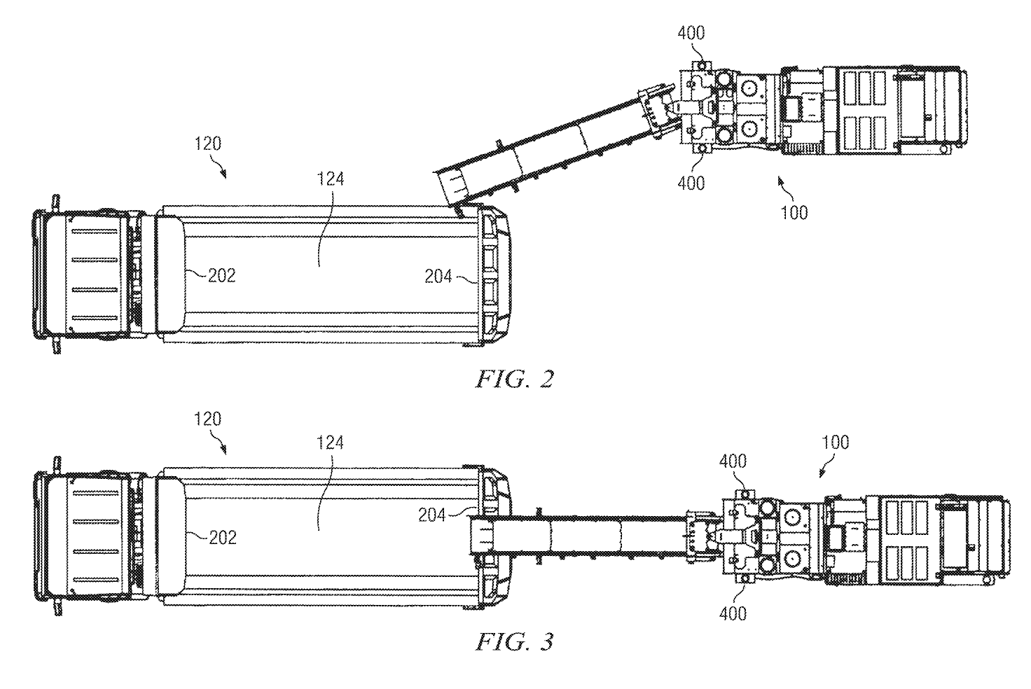

As illustrated in FIGS. 2 and 3, the forward vehicle 120 and the rear vehicle 100 do not necessarily need to be in linear alignment. The vehicles 100, 120 may be positioned in any configuration which produces an acceptable result, specifically, any configuration in which the material from the delivery system from the rear vehicle 100 (a milling machine in this embodiment) fills the open receptacle 124 of the forward vehicle 120. If the forward vehicle 120 is too far from the milling machine 100, the excavated roadway will not clear the conveyor to fill the bed of the forward vehicle 120. If the forward vehicle 120 is too close to the milling machine 100, the conveyor 102 may make contact with the forward vehicle 120 and be damaged. In addition, if the vehicles 100, 120 remain separated by a distance that is relatively constant, the open bed 124 of the forward vehicle 120 will not be filled evenly. The most efficient filling of the open bed 124 occurs when the veil of material traverses repeatedly from a front 202 of the open bed 124 to a rear 204 of the open bed 124 or vice versa.

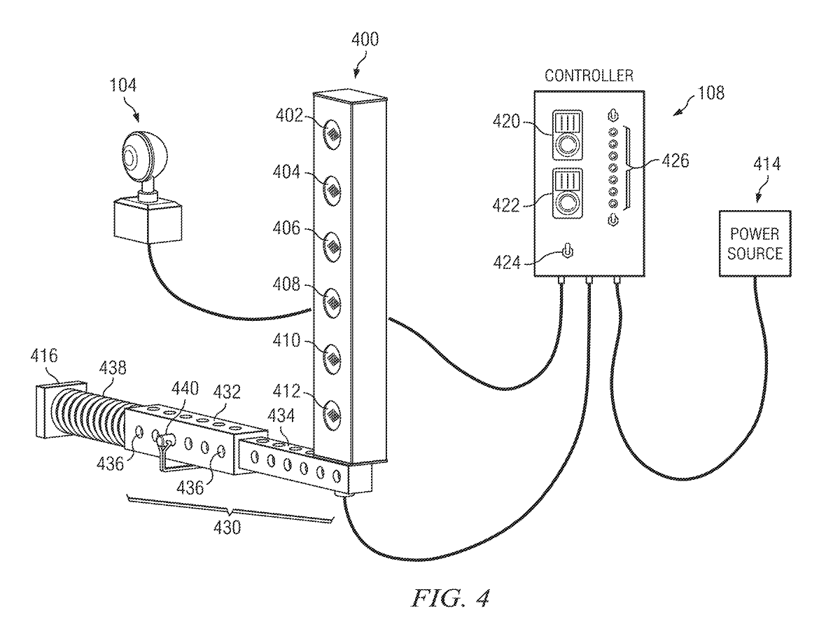

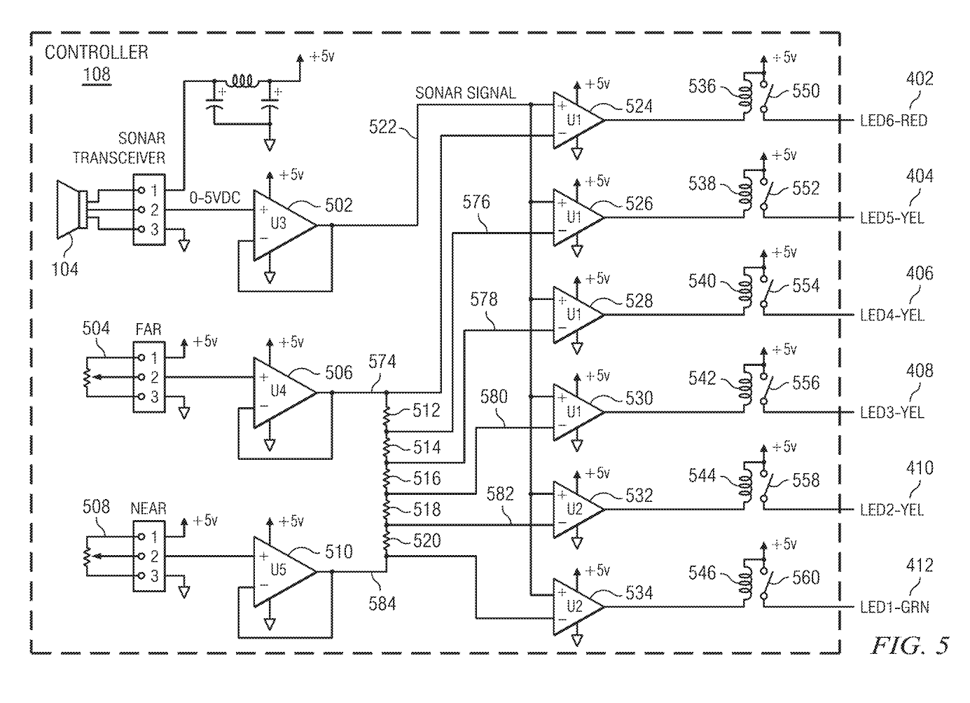

FIG. 4 illustrates one embodiment of a sonar positioning system according to the invention. In the embodiment illustrated in FIG. 4, the light indicator 106 is a light bar 400 and preferably there are two light bars 400 attached to opposing sides of the milling machine. Other embodiments may have one or more light indicators 106 which are not light bars 400. The light bar 400 in this embodiment has six light outputs 402-412. Other embodiments may have any number of light outputs 402-412 as long as there are at least two light outputs; in another embodiment there are three light outputs. The light outputs 402-412 may contain one or multiple light emitting diodes (LED), incandescent bulbs, fluorescent bulbs or any other light producing device which yields acceptable results.

The light outputs 402-412 on the light bar 400 may be of similar color or they may differ in color. In the embodiment shown in FIG. 4, the top light output 402 is red, the intermediate light outputs 404-410 are yellow and the bottom light output 412 is green. Other patterns and colors may be used on alternative embodiments.

The light indicator 106 is attached to either the first vehicle 100 or the second vehicle 120. In the embodiment shown in FIGS. 1-3 there are two light bars 400 attached to the milling machine 100. The light bar 400, as illustrated in FIG. 4, is attached to the milling machine 100 via an extendable arm 430. The extendable arm 430 allows the light bar 400 to be rotated in two axes so that the operator of the forward vehicle 120 has an unobstructed sightline to one or both light bars 400. In the embodiment illustrated in FIG. 4 the extendable arm 430 is made from a rectangular metal pole 434 telescoped in a second rectangular pole 432. Each of the poles 432, 434 has many holes 436. In operation, the inner pole 434 is adjusted to the preferred length and a securing device, such as a bolt 440, is slid through the aligned holes 436 and releasably attached, thereby securing the poles 432, 434 in the predetermined position. The extendable arm may incorporate a spring 438. The spring 438 allows the light bar 400 to hit obstacles alongside the road, such as road signs, without breaking. Other embodiments may have extendable arms 430 which may or may not be adjustable or may adjust in different ways.

The light bar 400 in the illustrated embodiment is approximately two feet in height and encased in a polycarbonate tube with rounded edges. Other heights and materials may be used for the light bar 400 as long as it produces acceptable results and is visible by the driver of the forward vehicle 120. The light bar 400 may be attached to the first or second vehicle 100, 120 with a bracket 416, bolts, welding or any other method which yields acceptable results.

As illustrated in FIG. 1, the sonar transmitter and receiver may be housed in one sonar device 104. Preferably the sonar device 104 is a transceiver which emits a sonar pulse and receives the reflected pulse off of the sensed vehicle in an manner in which allows the distance between the two vehicles 100, 120 to be gauged.

In the illustrated embodiment, the sonar device 104 transmits a sonar signal from a position on the milling machine 100 to the forward vehicle 120. Generally the sonar device 104 may be mounted on any part of the milling machine 100 that yields acceptable results. Preferably the sonar device 104 is mounted on the front of the milling machine 100 on the underside of the conveyor 102. This positioning allows the sonar device 104 to project a signal onto the forward vehicle 120. The vehicle tailgate 122 provides a flat target for receipt and reflection of the sonar pulses and for return to the sonar device 104. The signal is then returned to the sonar device 104 after it bounces off of the forward vehicle 120.

Sonar devices 104 selected may be those which run from a 0 to 5 volt analog signal having a range of 0 to 10 meters such as those available from MaxBotix of Brainerd, Minn. including the Model 7363. These sonar devices 104 generally allow a near range of about 15 inches and a far range of about 32 feet. Any sonar device 104 that provides acceptable results may be selected.

As illustrated in FIG. 4, the controller 108 has two dials or knobs 420, 422. Each of the dials 420, 422 may have a digital dial display 440, 442 associated with it. The controller 108 may have a series of small lights 426 that correspond to light outputs 402-412 on the light bar 400. In addition the lights 426 on the controller 108 may have an additional light that indicates when the controller 108 is powered. The illustrated embodiment of the controller has a toggle on/off switch 424.

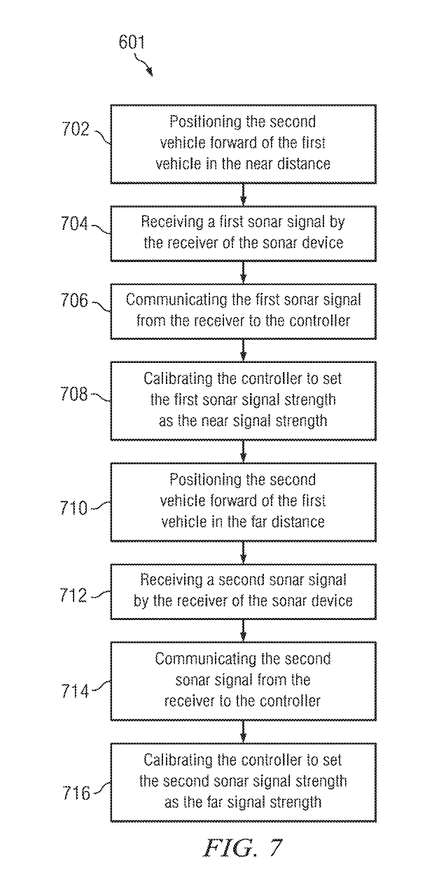

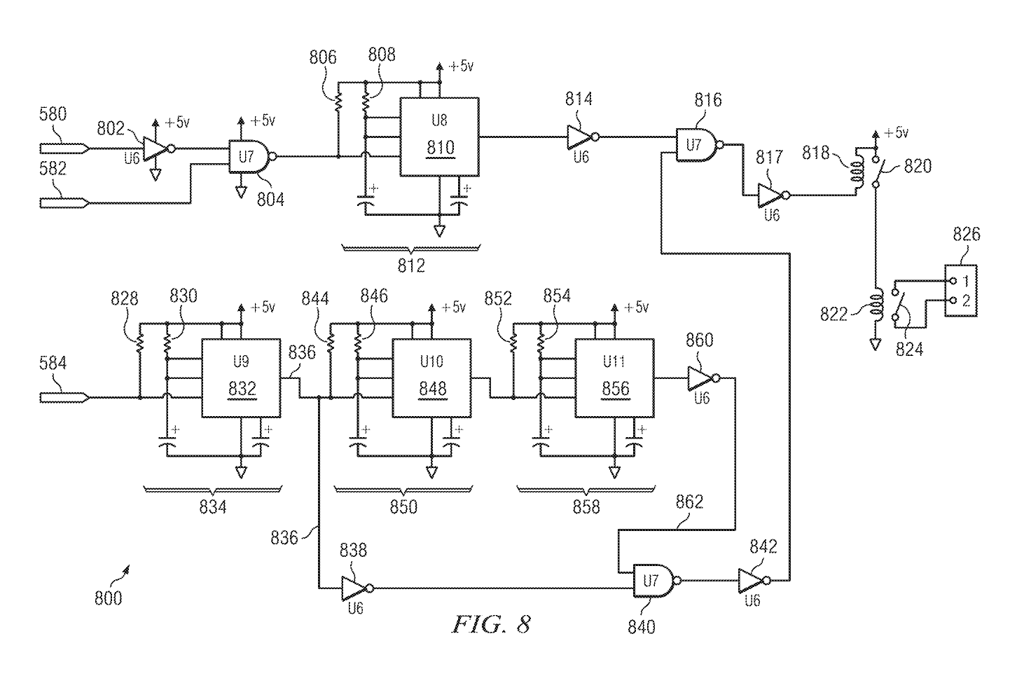

As shown in FIGS. 4 and 5, a controller 108 receives the output from the sonar device 104 which is the strength of the reflected signal. The controller 108 controls the light indicator 106. The controller 108 may be calibrated before use using the two potentiometers 504, 508 which in this embodiment are mechanically connected to two dials 420, 422 on the outside of the controller. Other embodiments may have different calibration means. To calibrate the controller 108, the forward vehicle 120 is placed in a position furthest from the rear vehicle 100, yet at a distance in which the material leaving the conveyor 102 or delivery system of the rear vehicle 100 lands in the open receptacle 124 of the forward vehicle 120. The dial 420 connected to the first potentiometer 504 on the controller 108 is turned such that one light, such as light 402, on the light indicator 106 is illuminated. The dial 420 may have a display 440 corresponding to the distance, in centimeters, between the sonar device 104 and the forward vehicle 120. See also FIG. 7.

The forward vehicle 120 is then placed in a position closest to the rear vehicle 100, yet at a distance in which the material leaving the conveyor 102 or delivery system of the rear vehicle 100 lands in the open receptacle of the forward vehicle 120. The dial 422 connected to the second potentiometer 508 is turned such that at least two lights, such as lights 402, 412 on the light indicator 106 are illuminated. If the light bar 400 has intermediate lights, the intermediate lights 404-410 are also illuminated. The dial 422 may have a display 442 corresponding to the distance, in centimeters, between the sonar device 104 and the forward vehicle 120. Once the calibration is completed, the numbers from the displays 440, 442 can be recorded and the settings used for any second vehicle 120 of an identical make and model as long as the sonar device 104 remains mounted in the same position on the conveyor 102.

The values of the signal strengths determined by the settings of the two potentiometers 504, 508 (FIG. 5) are passed through respective operational amplifiers 506, 510. The operational amplifiers 506, 510 may be chip TC271CP or any other chip that yields acceptable results.

Analog comparators 524, 534 compare the reflected signal 522 with the settings for the near position or distance and the far position or distance. If the forward vehicle 120 is in the far position, the controller 108 actuates only one light output, such as light 402. If the forward vehicle 120 is in the near position, the controller 108 actuates at least light outputs 402 and 412. In the near position intermediate lights 404-410 are also illuminated. Chip LM239 may be used for the analog comparators 524, 534.

In embodiments in which there are more than two light outputs such as six 402-412, the controller 108 divides the reflected signal strength on output 522 into as many intermediate signals as there are light outputs 402-412 on the light indicator 106. In the embodiment illustrated in FIGS. 4 and 5, the range of signal strengths between the two potentiometer settings is divided into five equal ranges using resistors 512-520. For example if the signal strength relating to the far position is 0.5 volts and the signal strength relating to the close position is 4.5 volts, the resistors 512-520 would divide the range between 0.5 and 4.5 volts into 5 equal values, or intermediate signal strength values.

The embodiment shown in FIG. 5 illustrates six light outputs 402-412. The controller 108 receives the reflected signal from the sonar device 104. The reflected signal is passed through operational amplifier 502 and to each of six analog comparators 524-534 in parallel. Analog comparator 524 compares the reflected signal strength at 522 against the signal strength for the far position (output 574). If the value of the reflected signal strength 522 is greater than or equal to the value for the signal strength relating to the far position at 574, control relay 536 will energize and relay contact 550 will close and the corresponding light output 402 will be turned on. In this embodiment light output 402 for the far position is red.

Analog comparator 526 compares reflected signal strength 522 against an intermediate signal strength present on line 576. If the value of reflected signal strength 522 is greater than intermediate signal strength 576, control relay 538 will energize, relay contact 552 will close and light output 404 will be turned on. In this embodiment light output 404 is yellow.

Analog comparator 528 compares reflected signal strength 522 against an intermediate signal strength present on line 578. If the value of reflected signal strength 522 is greater than intermediate signal strength 578, control relay 540 will energize, relay contact 554 will close and light output 406 will be turned on. In this embodiment light output 406 is yellow.

Analog comparator 530 compares reflected signal strength 522 against an intermediate signal strength present on line 580. If the value of reflected signal strength 522 is greater than intermediate signal strength 580, control relay 542 will energize, relay contact 556 will close and light output 408 will be turned on. In this embodiment light output 408 is yellow.

Analog comparator 532 compares reflected signal strength 522 against an intermediate signal strength present on line 582. If the value of reflected signal strength 522 is greater than intermediate signal strength 582, control relay 544 will energize, relay contact 558 will close and light output 410 will be turned on. In this embodiment light output 410 is yellow.

Analog comparator 534 compares reflected signal strength 522 against the signal strength for the near position appearing on line 584. If the value of the reflected signal strength 522 is greater than the value for the signal strength relating to the near position 584, control relay 546 will energize, relay contact 560 will close and light output 412 will be turned on. Light output 412 corresponding to the near position is green. There are sixteen LED's per light output 402-412 in the illustrated embodiment. The circuitry in the controller 108 may be configured any way that produces acceptable results. In addition, the values for 580, 582 and 584 may be used as input for an audio indicator if applicable.

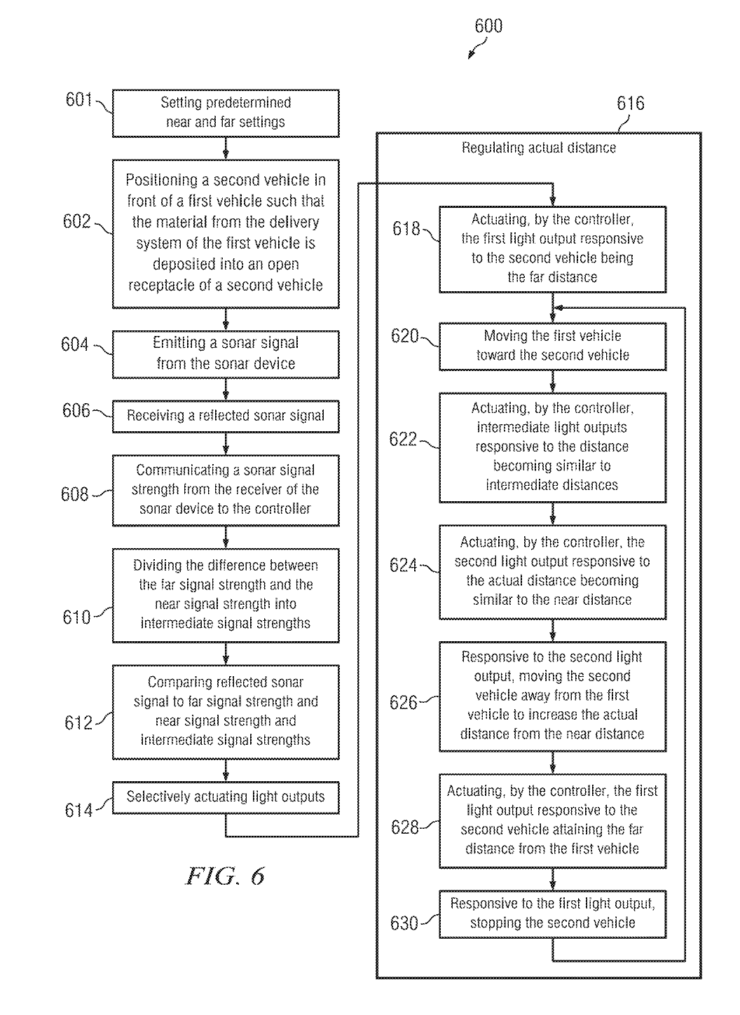

FIG. 6 illustrates a further aspect of the invention in which a method 600 for positioning two vehicles 100, 120 using a sonar device 104 is accomplished. First and at step 601, the controller 108 is calibrated, the steps for which are set forth in FIG. 7. In accordance with the invention, the method begins by positioning 602 a second vehicle 120 in front of a first vehicle 100 such that the material from the delivery system 102 of the first vehicle or milling machine 100 is deposited into an open bed 124 of the second vehicle 120. In the illustrated embodiment, the first vehicle is a milling machine 100 and the second vehicle 120 is a vehicle with an open bed 124.

Next, at step 604 a sonar signal is emitted from the transmitter of a sonar device 104 mounted on the first vehicle 100. At step 606 a sonar signal reflected back from the second vehicle 120 is received by the receiver of the sonar device 104. Next, controller 108 communicates 608 a sonar signal strength from the receiver of the sonar device to the controller 108. At step 610, the controller 108 divides the difference between the predetermined far signal strength corresponding to a predetermined far distance between the first 100 and second 120 vehicles, and a predetermined near signal strength corresponding to a predetermined near distance between the first 100 and second 120 vehicles into intermediate signal strengths. At step 612 the sonar signal strength is compared to the predetermined near and far signal strengths. Responsive to the step of comparing, at step 614, the controller 108 selectively actuates the first light output 402, the second light output 412 or a predetermined combination of them; intermediate lights 404-410 may be actuated as well. At step 616, an actual distance of the first vehicle to the second vehicle is regulated by the vehicle operator responsive to the controller 108 selectively actuating the first light output 402 or the second light output 412 or a predetermined combination of them and/or intermediate lights 404-410.

The regulating step 616 includes substeps 618-630. The controller 108 actuates 618 the first light output 402 responsive to the second vehicle 120 being at the far distance from the first vehicle 100. The first vehicle 100 is moved 620 toward the second vehicle 120 to decrease the actual distance from the far distance. The controller 108 actuates intermediate light outputs 404-410 responsive to the actual distance becoming similar to the intermediate signal strengths. The controller 108 actuates 624 the second light output 412 responsive to the actual distance becoming similar to the near distance. Responsive to the second light output, the operator moves 626 the second vehicle 120 away from the first vehicle 100 to increase the actual distance from the near distance. At step 628 the controller 108 actuates the first light output 402 responsive to the second vehicle 120 attaining the far distance from the first vehicle. Responsive to the first light output, the operator stops 630 the second vehicle 120. Steps 618-630 are repeated the desired number of times.

FIG. 7 illustrates a further aspect of the invention which is a method 601 for calibrating the controller 108. At step 702 the second vehicle 120 is positioned forward of the first vehicle 100 in the near distance, which is the closest position possible where the first and second vehicles 100, 120 do not collide, yet material from the delivery system of the first vehicle 100 is deposited into the open receptacle 124 of the second vehicle 120. At step 704 a first sonar signal is received by the receiver of the sonar device 104. At step 706 the first sonar signal strength is communicated from the receiver to the controller 108. At step 708 the controller 108 is calibrated to set the first sonar signal strength as the near signal strength. At step 710 the second vehicle 120 is positioned forward of the first vehicle 100 at the far distance. At step 712 a second sonar signal is received by the receiver of the sonar device. At step 714 the second sonar signal is communicated from the receiver to the controller 108. At step 716 the controller 108 is calibrated to set the second sonar signal strength as the far signal strength.

In another embodiment illustrated in FIG. 8, an audio indicator 826 is actuated by the controller 108. The audio indicator may be a horn, either an independent horn of the horn of the first vehicle 100. Alternative embodiments may have different audio indicators. An audio signal of two short beeps is actuated when the second vehicle is in the near distance. An audio signal of one long beep is actuated when the second vehicle is in the far distance. Alternative embodiments may have different horn sequences and durations.

The embodiment illustrated in FIG. 8 uses values 580, 582 and 584 (See FIG. 5) as input to the circuit 800. Value 580 is passed through inverter 802. Inverter 802 may use chip 74LS04 or other chip that yields acceptable results. The value of 582 and the value from inverter 802 are passed to nand gate 804. Nand gate 804 may use chip 74LS00 or any other chip that yields acceptable results. The output from nand gate 804 is passed to timer 812. Timer 812 is set to run for 2 seconds but different embodiments may run for different amounts of time. The timer 812 duration may be changed by using different resistors 806, 808. Timer 812 may use chip LM555 (810) or any other chip that yields acceptable results. The value from timer 812 is passed to inverter 814. Inverter 814 may use chip 74LS00 or other chip that yields acceptable results. The value from inverter 814 is passed to nand gate 816. Nand gate 816 may use chip 74LS00 or any other chip that yields acceptable results.

The value 584 is passed through timer 834. Timer 834 runs for 0.5 seconds. Again, the duration of timer 834 may be changed by changing resistors 828, 830. Value 836 is passed through inverter 838 and to timer 850. Timer 850 runs for 0.25 seconds. The duration of timer 850 may be changed by changing the resistors 844, 846. Timers 834 and 850 may use chip LM555 (832, 848) or any other chip that yields acceptable results.

Value 836 is also passed to inverter 838. Inverter 838 may use chip 74LS04 or any other chip that yields acceptable results. The value from inverter 838 is passed to nand gate 840. The nand gate 840 may use chip 74LS00 or any other chip that yields acceptable results.

Value 851 is passed to timer 858. Timer 858 runs for 0.5 seconds. The duration of timer 858 may be changed by changing resistors 852 and 854. Timer 858 may use chip LM555 (856) or any other chip that yields acceptable results.

The output of timer 858 is passed through inverter 860 and to nand gate 840. Inverter 860 may use chip 74LS04 or any other chip that yields acceptable results. The output of inverter 860, value 862, is passed to nand gate 840. Nand gate 840 uses chip 74LS00 or any other chip that yields acceptable results. The output of nand gate 840 is passed through inverter 842. Inverter 842 may use a 74LS04 chip or any other chip that yields acceptable results. The output of inverter 842 is passed to nand gate 816. Nand gate 816 may use chip 74LS00 or any other chip that yields acceptable results.

The output of nand gate 816 is passed through inverter 817. Inverter 817 may use chip 74LS04 or any other chip that yields acceptable results. If control relay 818 is energized, relay contact 820 will close. When energized, power relay 822 will close relay contact 824 and the audio indicator 826, or horn contact in this embodiment, will be activated. The horn will sound one two second beep for the second vehicle 120 being in the far position. The horn will sound a 0.5 second beep followed by a 0.25 second pause followed by a 0.5 second beep for the second vehicle 120 being in the near position.

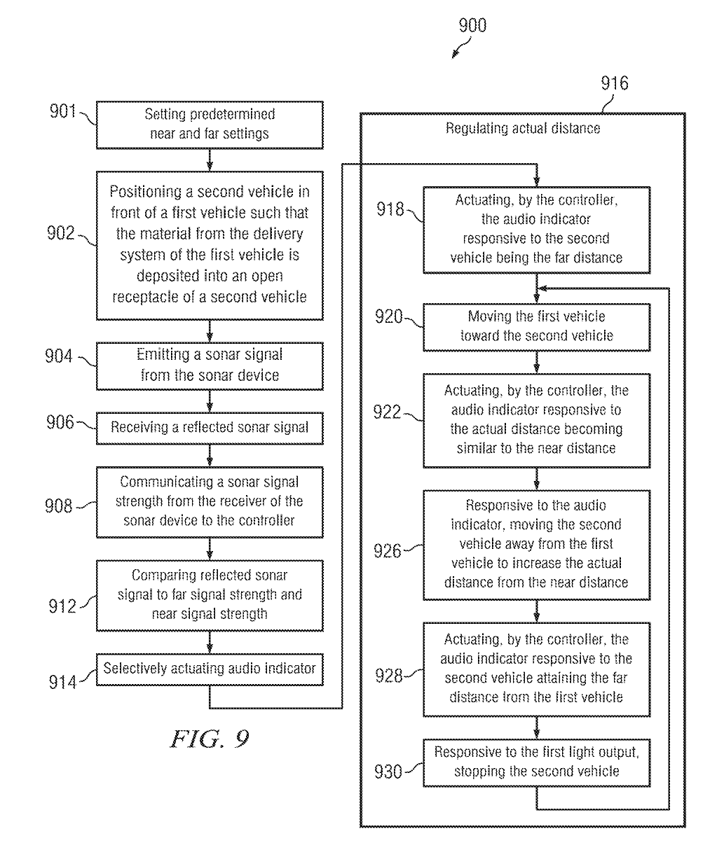

FIG. 9 illustrates a further aspect of the invention in which a method 900 for positioning two vehicles 100, 120 using a sonar device 104 and audio indicator 826 is accomplished. First and at step 901, the controller 108 is calibrated, the steps for which are set forth in FIG. 7. In accordance with the invention, the method begins by positioning 902 a second vehicle 120 in front of a first vehicle 100 such that the material from the delivery system 102 of the first vehicle or milling machine 100 is deposited into an open bed 124 of the second vehicle 120. In the illustrated embodiment, the first vehicle is a milling machine 100 and the second vehicle 120 is a vehicle with an open bed 124.

Next, at step 904 a sonar signal is emitted from the transmitter of a sonar device 104 mounted on the first vehicle 100. At step 906 a sonar signal reflected back from the second vehicle 120 is received by the receiver of the sonar device 104. Next, controller 108 communicates 908 a sonar signal strength from the receiver of the sonar device to the controller 108. At step 912 the sonar signal strength is compared to the predetermined near and far signal strengths. Responsive to the step of comparing, at step 914, the controller 108 selectively actuates an audio signal of two short beeps if the second vehicle is in the near distance or an audio signal of one long beep if the second vehicle is in the far distance.

The regulating step 916 includes substeps 918-930. The controller 108 actuates 918 an audio signal of one long beep if the second vehicle 120 is in the far distance. The first vehicle 100 is moved 920 toward the second vehicle 120 to decrease the actual distance from the far distance. The controller 108 actuates 922 the audio indicator to produce two short beeps responsive to the actual distance becoming similar to the near distance. Responsive to the two short beeps, the operator moves 926 the second vehicle 120 away from the first vehicle 100 to increase the actual distance from the near distance. At step 928 the controller 108 actuates the audio indicator to produce one long beep responsive to the second vehicle 120 attaining the far distance from the first vehicle. Responsive to the one long beep, the operator stops 930 the second vehicle 120. Steps 918-930 are repeated the desired number of times.

In summary, a method and apparatus has been illustrated and described by which sonar signals and light-emitting apparatus are used to regulate the distance of two moving vehicles between acceptable near and far distances.

Although the present invention has been described by reference to its preferred embodiment as is disclosed in the specification and drawings above, many more embodiments of the present invention are possible without departing from the invention. Thus, the scope of the invention should be limited only by the impended claims.

We claim:

1. A sonar positioning system, comprising:
a first vehicle, a sonar device mounted on the first vehicle, the sonar device including a transmitter and a receiver, the receiver having an output;
a second vehicle, the second vehicle forwardly displaced from the first vehicle by an actual distance;
a light indicator, at least two light outputs disposed on the light indicator;
a controller, an input of the controller coupled to the output of the receiver of the sonar device, the controller having first and second settings, a first setting corresponding to a first signal strength relating to a near distance between the first and second vehicles and a second setting corresponding to a second signal strength relating to a far distance between the first and second vehicles;
wherein the sonar device projects a signal onto the second vehicle and receives a reflected signal, the reflected signal having a strength and being a function of the actual distance between the first and second vehicles, the strength of the reflected signal being communicated from the receiver of the sonar device to the controller, the controller comparing the strength of the reflected signal to the first and second signal settings, the controller coupled to the light indicator and actuating one or more of the light outputs when the reflected signal strength is greater or equal to the first signal strength and less than or equal to the second signal strength.

2. The system of claim 1, wherein the first vehicle has a conveyor belt.

3. The system of claim 1, wherein the first vehicle is a milling machine.

4. The system of claim 1, wherein the second vehicle is a truck with an open bed box.

5. The system of claim 1, wherein the light indicator is a light bar having a plurality of light outputs disposed in a line, the controller selectively actuating the light outputs as a function of the actual distance.

6. The system of claim 1, wherein the light indicator is electrically connected to an output of the controller.

7. The system of claim 1, wherein two light indicators are removably attached to the first vehicle.

8. The system of claim 1, wherein the light indicator is attached to the first vehicle by an extendable arm and is adjustable in at least two axes.

9. The system of claim 8, wherein the extendable arm includes a spring.

10. The system of claim 1, wherein the controller actuates the first light output when the second vehicle is at the near distance, and wherein the controller actuates the second light output when the second vehicle is at the far distance.

11. The system of claim 10, wherein the light indicator further includes one or more further light outputs in addition to the first and second light outputs, the controller dividing the difference between the first signal strength and the second signal strength into a plurality of intermediate values corresponding to the number of further light outputs, the controller comparing the strength of the reflected signal to one of the intermediate values and actuating at least a corresponding one of the further light outputs as a function of the similarity of the strength of the reflected signal to one of the intermediate values.

12. The system of claim 1, wherein the first output is a different color than the second light output.

13. A method for maintaining a predetermined distance between two vehicles comprising the steps of:
positioning a second vehicle in front of a first vehicle such that material from the a delivery system of the first vehicle is deposited into an open receptacle of the second vehicle;
emitting a sonar signal from a transmitter of a sonar device mounted on the first vehicle;
responsive to said step of emitting, receiving a sonar signal reflected back from the second vehicle by a receiver of the sonar device;
communicating a sonar signal strength from the receiver of the sonar device to a controller;
setting in the controller a predetermined far signal strength corresponding to a predetermined far distance between the first and second vehicles and a predetermined near signal strength corresponding to a predetermined near distance between the first and second vehicles;
comparing the sonar signal strength to the predetermined far signal strength and the predetermined near signal strength;
responsive to said step of comparing, selectively actuating, by the controller, ones of at least first and second light outputs; and
regulating an actual distance of the first vehicle to the second vehicle responsive to the controller selectively actuating at least the first and second light outputs, the step of regulating including the substeps of:
(a) actuating, by the controller, the first light output responsive to the second vehicle being the far distance to the first vehicle;
(b) moving the first vehicle toward the second vehicle to decrease the actual distance from the far distance;
(c) actuating, by the controller, the second light output responsive to the actual distance becoming similar to the near distance;
(d) responsive to the second light output, moving the second vehicle away from the first vehicle to increase the actual distance from the near distance;
(e) actuating, by the controller, the first light output responsive to the second vehicle attaining the far distance from the first vehicle; and
(f) responsive to the first light output, stopping the second vehicle.

14. The method of claim 13, wherein the step of regulating the actual distance of the first vehicle to the second vehicle includes the substep of
(g) repeating substeps (b)-(f) a desired number of times.

15. The method of claim 13, and further comprising the steps of:
dividing, by the controller, the difference between the near signal strength and the far signal strength into one or more intermediate signal strengths;
comparing the sonar signal strength to each of the intermediate signal strengths; and
responsive to the sonar signal strength being similar to one of the intermediate signal strengths, actuating at least a third light output associated with the first and second light outputs.

16. The method of claim 15, and further comprising the step of
upon determining, by the controller, that the sonar signal strength is similar to an intermediate signal strength, actuating at least the first light output and the third light output.

17. The method of claim 13, further including the step of calibrating the controller, the step of calibrating the controller comprising the substeps of:
positioning the second vehicle forward of the first vehicle at the near distance;
receiving a first sonar signal by the receiver of the sonar device;
communicating a first sonar signal strength from the receiver to the controller;
calibrating the controller to set the first sonar signal strength as the near signal strength;
positioning the second vehicle forward of the first vehicle at the far distance;
receiving a second sonar signal by the receiver of the sonar device;
communicating a second sonar signal strength from the receiver to the controller; and
calibrating the controller to set the second sonar signal strength as the far signal strength.

18. A sonar positioning system, comprising:
a first vehicle, a sonar device mounted on the first vehicle, the sonar device including a transmitter and a receiver, the receiver having an output;
a second vehicle, the second vehicle forwardly displaced from the first vehicle by an actual distance;
an audio indicator;
a controller, an input of the controller coupled to the output of the receiver of the sonar device, the controller having first and second settings, a first setting corresponding to a first signal strength relating to a near distance between the first and second vehicles and a second setting corresponding to a second signal strength relating to a far distance between the first and second vehicles;
wherein the sonar device projects a signal onto the second vehicle and receives a reflected signal, the reflected signal having a strength and being a function of the actual distance between the first and second vehicles, the strength of the reflected signal being communicated from the receiver of the sonar device to the controller, the controller comparing the strength of the reflected signal to the first and second signal settings, the controller coupled to the audio indicator and actuating the audio indicator when the reflected signal strength is equal to the first signal strength and equal to the second signal strength.

19. The system of claim 18, wherein the audio indicator is a horn.

20. The system of claim 18, wherein the audio indicator is a horn of a milling machine.

21. A method for maintaining a predetermined distance between two vehicles comprising the steps of:
positioning a second vehicle in front of a first vehicle such that material from the a delivery system of the first vehicle is deposited into an open receptacle of the second vehicle;
emitting a sonar signal from a transmitter of a sonar device mounted on the first vehicle;
responsive to said step of emitting, receiving a sonar signal reflected back from the second vehicle by a receiver of the sonar device;
communicating a sonar signal strength from the receiver of the sonar device to a controller;
setting in the controller a predetermined far signal strength corresponding to a predetermined far distance between the first and second vehicles and a predetermined near signal strength corresponding to a predetermined near distance between the first and second vehicles;
comparing the sonar signal strength to the predetermined far signal strength and the predetermined near signal strength;
responsive to said step of comparing, selectively actuating, by the controller, the audio indicator; and
regulating an actual distance of the first vehicle to the second vehicle responsive to the controller selectively actuating the audio indicator, the step of regulating including the substeps of:
(a) actuating, by the controller, the audio indicator responsive to the second vehicle being the far distance to the first vehicle;
(b) moving the first vehicle toward the second vehicle to decrease the actual distance from the far distance;
(c) actuating, by the controller, the audio indicator responsive to the actual distance becoming similar to the near distance;
(d) responsive to the second light output, moving the second vehicle away from the first vehicle to increase the actual distance from the near distance;
(e) actuating, by the controller, the audio indicator responsive to the second vehicle attaining the far distance from the first vehicle; and
(f) responsive to the first light output, stopping the second vehicle.

22. The method of claim 21, wherein the step of regulating the actual distance of the first vehicle to the second vehicle includes the substep of
(g) repeating substeps (b)-(f) a desired number of times.
